(19) United States
(12) Patent Application Publication
(10) Pub. No.: US 2025/0188221 A1
(43) Pub. Date: Jun. 12, 2025

(54) THICKENING ALKYLATED URTHEANE COPOLYMER

(71) Applicant: COATEX, Genay (FR)

(72) Inventors: Guillaume MICHAUD, Lyon (FR); Denis RUHLMANN, Genay (FR); Jean-Marc SUAU, Lucenay (FR)

(73) Assignee: COATEX, Genay (FR)

(21) Appl. No.: 18/845,596

(22) PCT Filed: Mar. 10, 2023
(86) PCT No.: PCT/FR2023/000023

§ 371 Date: Sep. 10, 2024

(30) Foreign Application Priority Data
Mar. 18, 2022 (FR) 2202412

(51) Int. Cl. C08G 71/04; C09D 175/04; C09J 175/04

(52) U.S. Cl. CPC C08G 71/04; C09D 175/04; C09J 175/04

(57) ABSTRACT

A thickening urethane copolymer which is prepared using a non-alkoxylated Guerbet alcohol comprising a double-branched alkyl group and a process for preparing the thickening urethane copolymer. The thickening urethane copolymer is used in aqueous compositions, in particular in coating compositions.

The invention relates to a thickening urethane copolymer prepared using a non-alkoxylated Guerbet alcohol comprising a double-branched alkyl group. The invention also relates to the process for preparing this copolymer and to the use thereof in aqueous compositions, in particular in coating compositions.

Many technical fields require the use of aqueous compositions. These include, in particular, aqueous hydraulic binder compositions, aqueous adhesive compositions, aqueous detergent compositions, aqueous cosmetic compositions, aqueous ink compositions, aqueous paper coating compositions, aqueous coating compositions, in particular aqueous varnish compositions or aqueous paint compositions, for example aqueous decorative paint compositions or aqueous industrial paint compositions. In addition to their functional properties, these aqueous compositions must have a texture adapted to their use or to their storage. In particular, they must have a suitable viscosity. Moreover, it must be possible to use these aqueous compositions in conditions that can vary greatly. In particular, the viscosity of these aqueous compositions can change or degrade. The functional properties of these aqueous compositions can therefore be altered if their rheological behaviour is not adapted, for example to prevent settling or phase separation phenomena over the course of their storage, which can also appear as variations in viscosity. Such changes or degradations are particularly detrimental or damaging to aqueous hydraulic binder compositions, to aqueous adhesive compositions, to aqueous detergent compositions, to aqueous cosmetic compositions, to aqueous ink compositions, to aqueous paper coating compositions, to aqueous coating compositions, in particular to aqueous varnish or paint compositions.

There is therefore a need to be able to have aqueous compositions that do not have such disadvantages or aqueous compositions that do not lead to such problems.

In particular, it is especially useful to be able to have aqueous coating compositions, particularly aqueous varnish or paint compositions, whose viscosity is adapted to maintain both their homogeneity and the integrity of their functional properties. Maintaining the viscosity and limiting the loss of viscosity of these aqueous compositions should be possible for wide ranges of shear gradients.

As a result, many aqueous coating compositions use rheology-modifying polymers. These polymers should make it possible to impart the desired rheological properties to aqueous compositions over wide ranges of shear rates. These polymers should also improve shear thinning in these aqueous compositions by giving them sufficient pseudo-plastic behaviour, ensuring their stability and homogeneity over the course of their storage, facilitating their transfer to application tools and helping to limit the appearance of drips once they have been applied. The compatibility of the various constituents in an aqueous coating composition must also be considered. It is particularly important that the thickening copolymer and the pigments and binders used are suitably compatible.

It is also important to improve the pigment compatibility of aqueous coating compositions, particularly paint compositions and in particular with regard to the addition of pigment concentrates used for colouring. Without good pigment compatibility, the rheology of the composition can be severely degraded. Inadequate pigment compatibility can also lead to reduced colouring strength and result in an uneven or washed-out shade, which can lead to the use of a higher amount of pigment or to aesthetic flaws in the final coating. Document WO 2019091819 describes an aqueous composition comprising a surfactant compound and a polyurethane polymer prepared from a Guerbet alcohol obtained by condensing two straight-chain alcohols. Document EP 1806386 describes a composition comprising two thickening polymers prepared from a hydrophobic compound obtained by condensing two straight-chain alcohols. Document WO 2022023621 describes diurethane compounds prepared from polyethoxylated Guerbet alcohols.

The known polymers used as thickening agents do not always provide a satisfactory solution to these different problems. There is therefore a need for improved rheology-modifying copolymers. The copolymer according to the invention makes it possible to provide a solution to all or part of the problems of the polymers in the prior art.

Thus, the invention provides a copolymer P prepared by at least one polymerisation reaction:
of at least one isocyanate compound (a) independently chosen among a diisocyanate compound (al), a polyisocyanate compound (a2) and combinations thereof;
of at least one polyhydroxylated compound (b);
of at least one compound (c) obtained by dimerisation, by a Guerbet reaction, of two identical or different compounds of formula I:

R—CH[(CH₂)ₘCH₃]—(CH₂)ₙ—OH (I)
wherein:
R independently represents a straight C₄-C₉-alkyl group;
m independently represents 0 or 1;
n independently represents a number ranging from 2 to 7.

Preferably for the copolymer P according to the invention, the isocyanate compound (a) is a diisocyanate compound (a1) chosen among:
the symmetric aromatic diisocyanate compounds, preferably:
   2,2′-diphenylmethylene diisocyanate (2,2′-MDI) and 4,4′-diphenylmethylene diisocyanate (4,4′-MDI);
   4,4′-dibenzyl diisocyanate (4,4′-DBDI);
   2,6-toluene diisocyanate (2,6-TDI);
   m-xylylene diisocyanate (m-XDI);
-the symmetric c alicyclic diisocyanate compounds, preferably methylene bis(4-cyclohexylisocyanate) (H₁₂MDI);
the symmetric aliphatic diisocyanate compounds, preferably hexamethylene diisocyanate (HDI), pentamethylene diisocyanate (PDI);
the asymmetric aromatic diisocyanate compounds, preferably:
   2,4′-diphenylmethylene diisocyanate (2,4′-MDI);
   2,4′-dibenzyl diisocyanate (2,4′-DBDI);
   2,4-toluene diisocyanate (2,4-TDI);
the asymmetric alicyclic diisocyanate compounds, preferably isophorone diisocyanate (IPDI).

Preferably according to the invention, the compound (a1) is chosen among IPDI, HDI, H₁₂MDI and combinations thereof.

Also preferably for the copolymer P according to the invention, the isocyanate compound (a) can be a polyisocyanate compound (a2) strictly comprising more than 2 isocyanate groups or more than 2.2 isocyanate groups or even more than 2.5 isocyanate groups. More preferably, the polyisocyanate compound (a2) comprises more than 2.6 isocyanate groups or more than 2.7 isocyanate groups or more than 3 isocyanate groups. Also more preferably, the polyisocyanate compound (a2) comprises from 2.2 to 6 isocyanate groups, from 2.2 to 4 isocyanate groups, from 2.2 to 3.5 isocyanate groups, from 2.5 to 6 isocyanate groups, from 2.2 to 5 isocyanate groups, from 2.5 to 4 isocyanate groups, from 2.5 to 3.5 isocyanate groups, in particular from 2.6 to 3.3 isocyanate groups. Also preferably, the polyisocyanate compound (a2) is chosen among:
triphenylmethane-4,4′,4″-triisocyanate or 1,1′,1″-methylidynetris (4-isocyanatobenzene);
an isocyanurate compound, in particular an isocyanurate compound of a compound chosen among:
   the symmetric aromatic diisocyanate compounds, preferably:
      2,2′-diphenylmethylene diisocyanate (2,2′-MDI) and 4,4′-diphenylmethylene diisocyanate (4,4′-MDI);
      4,4′-dibenzyl diisocyanate (4,4′-DBDI);
      2,6-toluene diisocyanate (2,6-TDI);
      m-xylylene diisocyanate (m-XDI);
   the symmetric alicyclic diisocyanate compounds, preferably methylene bis(4-cyclohexylisocyanate) (H₁₂MDI);
   the symmetric aliphatic diisocyanate compounds, preferably hexamethylene diisocyanate (HDI), pentamethylene diisocyanate (PDI);
   the asymmetric aromatic diisocyanate compounds, preferably:
      2,4′-diphenylmethylene diisocyanate (2,4′-MDI);
      2,4′-dibenzyl diisocyanate (2,4′-DBDI);
      2,4-toluene diisocyanate (2,4-TDI);
a biuret trimer compound, in particular a biuret trimer compound of a compound chosen among:
   the symmetric aromatic diisocyanate compounds, preferably:
      2,2′-diphenylmethylene diisocyanate (2,2′-MDI) and 4,4′-diphenylmethylene diisocyanate (4,4′-MDI);
      4,4′-dibenzyl diisocyanate (4,4′-DBDI);
      2,6-toluene diisocyanate (2,6-TDI);
      m-xylylene diisocyanate (m-XDI);
   the symmetric alicyclic diisocyanate compounds, preferably methylene bis(4-cyclohexylisocyanate) (H₁₂MDI);
   the symmetric aliphatic diisocyanate compounds, preferably hexamethylene diisocyanate (HDI), pentamethylene diisocyanate (PDI);
   the asymmetric aromatic diisocyanate compounds, preferably:
      2,4′-diphenylmethylene diisocyanate (2,4′-MDI);
      2,4′-dibenzyl diisocyanate (2,4′-DBDI);
      2,4-toluene diisocyanate (2,4-TDI);
   the asymmetric alicyclic diisocyanate compounds, preferably isophorone diisocyanate (IPDI); preferably the compound (a2) is chosen among triphenylmethane-4,4′,4″-triisocyanate, 1,1′,1″-methylidynetris (4-isocyanatobenzene), an HDI isocyanurate, an IPDI isocyanurate, a PDI isocyanurate, an HDI biuret trimer and an IPDI biuret trimer, a PDI biuret trimer.

Preferably for the copolymer P according to the invention, the polyhydroxylated compound (b) is a compound (b1) of formula II:

HO—Lₚ—OH (II)
wherein:
L independently represents an oxyalkylene residue;
p independently represents a number ranging from 30 to 1,000.

Preferably for the copolymer P according to the invention, the polyhydroxylated compound (b) is a compound (b1) of formula II wherein:
L independently represents an oxyethylene residue; or
p independently represents a number ranging from 50 to 400, preferably from 100 to 300.

More preferably for the copolymer P according to the invention, the polyhydroxylated compound (b) is a compound (b1) of formula II wherein L independently represents an oxyethylene residue and p independently represents a number ranging from 50 to 400, preferably from 100 to 300.

According to the invention, the compound (b1) of formula II can be combined with a non-alkoxylated compound (b2) comprising at least three hydroxyl groups. Preferably according to the invention, the compound (b2) comprises three hydroxyl groups. Much more preferably, it is chosen among glycerol, pentaerythritol and combinations thereof. According to the invention, the polyhydroxylated compound (b) can also be polyethoxylated pentaerythritol or a polyalkoxylated compound (b3) comprising at least three hydroxyl groups. Preferably according to the invention, the compound (b3) is different from the compound (b2) and comprises three hydroxyl groups. Much more preferably, it is polyethoxylated glycerol.

Advantageously according to the invention, the copolymer P can be prepared using one or more combinations of the compounds (b1), (b2) and (b3).

Preferentially according to the invention, the compounds (b), (b1) or (b3) independently have a molar mass (Mw) measured by SEC ranging from 1,500 to 40,000 g/mol, preferably from 2,000 to 20,000 g/mol, more preferentially from 2,000 to 15,000 g/mol or from 2,000 to 12,000 g/mol. According to the invention, the molar mass of the compounds (b), (b1) or (b3) is determined by Size Exclusion Chromatography (SEC), a.k.a. “Gel Permeation Chromatography” (GPC). This technique uses a “Waters” liquid chromatography instrument equipped with a detector. This detector is a “Waters” 2414 refractive index detector. This liquid chromatography instrument is equipped with two size exclusion columns in order to separate the various molecular weights of the polymers or compounds studied. The liquid elution phase is an organic phase comprised of THF (HPLC grade, not stabilised). In a first step, about 25 mg of compound is dissolved in 5 mL of THE, to which is added 0.1 mol % of water used as internal flow marker. Then, the solution is filtered through a 0.2 μm filter. 50 μL are then injected into the chromatography instrument (eluent: THF, HPLC grade, not stabilised). The liquid chromatography instrument has an isocratic pump (“Waters” 515), the flow rate of which is set to 0.3 mL/min. The chromatography instrument also comprises an oven which comprises a system of columns in series: an “Agilent” PLgel MiniMIX-A column 250 mm long and 4.6 mm in diameter followed by an “Agilent” PLgel MiniMIX-B column 250 mm long and 4.6 mm in diameter. The detection system is comprised of a “Waters” 2414 RI refractive index detector. The columns are kept at a temperature of 35° C. and the refractometer is heated to 35° C. The chromatography instrument is calibrated using polymethyl methacrylate standards certified by the supplier, “Agilent” (“EasiVial” PMMA).

Essentially according to the invention, the compound (c) is obtained by a dimerisation reaction of two compounds of formula I. This dimerisation is a Guerbet reaction carried out with these two alcohols of formula I. The dimerisation reaction and the conditions under which it is carried out are known per se. The Guerbet reaction is generally carried out at high temperature and pressure, in a basic medium and in the presence of a catalyst. The compound (c) can be prepared using the same compound of formula I or using two different compounds of formula I.

Preferably according to the invention, the dimerisation of two identical compounds of formula I results in a homodimer (c1). Also preferably according to the invention, the compound (c) is a homodimer (c1) obtained by dimerisation of two identical compounds of formula I wherein:
R represents a straight C₅-C₇-alkyl group;
m represents 0 or 1, preferably 0;
n represents a number ranging from 2 to 7.

More preferably according to the invention, the compound (c) is a homodimer (c1) obtained by dimerisation of two identical compounds of formula I wherein
R represents a straight C₄-C₉-alkyl group, preferably a straight C₅-C₇-alkyl group;
m represents 0 or 1, preferably 0;
n represents a number ranging from 5 to 7, preferably from 4 to 6, more preferentially 4 or 5.

Particularly preferably according to the invention, the dimerisation is carried out using two different compounds of formula I and results in a mixture comprising 2 different homodimers (c1) and a heterodimer (c2). Preferably, this is a mixture consisting of 2 different homodimers (c1) and of a heterodimer (c2). Also preferably, a mixture of compounds (c) can be obtained by dimerisation of two different compounds of formula I wherein:
R independently represents a straight C₅-C₇-alkyl group;
m independently represents 0 or 1, preferably 0;
n independently represents a number ranging from 2 to 7.

Preferably according to the invention, a mixture of compounds (c) can be obtained by dimerisation of two different compounds of formula I wherein
R independently represents a straight C₄-C₉-alkyl group, preferably a straight C₅-C₇-alkyl group;
m independently represents 0 or 1, preferably 0;
n independently represents a number ranging from 5 to 7, preferably from 4 to 6, more preferentially 4 or 5.

A preferred mixture of compounds (c) comprises a heterodimer compound (c2) obtained by dimerisation of a first compound of formula I wherein R represents a straight Cs-alkyl group, m represents 0 and n represents 5 and of a second different compound of formula I wherein R represents a straight C₇-alkyl group, m represents 0 and n represents 4. A particularly preferred mixture of compounds (c) comprises:
a heterodimer compound (c2) obtained by dimerisation of a first compound of formula I wherein R represents a straight Cs-alkyl group, m represents 0 and n represents 5 and of a second different compound of formula I wherein R represents a straight C₇-alkyl group, m represents 0 and n represents 4,
a first homodimer (c1) obtained by dimerisation of a compound of formula I wherein R represents a straight C₅-alkyl group, m represents 0 and n represents 5,
a second homodimer (c1) obtained by dimerisation of a different compound of formula I wherein R represents a straight C₇-alkyl group, m represents 0 and n represents 4.

According to the invention, the dimerisation carried out using two different compounds of formula I can result in a mixture consisting of 2 different homodimers (c1) and of a heterodimer (c2).

When preparing the copolymer P according to the invention, the amounts of the compounds (a), (b) and (c) can vary. Preferably for the copolymer P, the polymerisation reaction uses:
from 10 to 79.9 mol % or from 10 to 74.5 mol %, preferably from 10 to 68 mol % or from 10 to 60 mol %, of monomer (a) or
from 20 to 89.9 mol % or from 25 to 89.5 mol %, preferably from 30 to 88 mol % or from 35 to 85 mol %, of monomer (b), or
from 0.1 to 70 mol % or from 0.5 to 65 mol %, preferably from 2 to 60 mol % or from 5 to 55 mol %, of monomer (c),
relative to the total molar amount of monomers (a), (b) and (c).

Also preferably according to the invention, the polymerisation reaction can use:
from 10 to 79.9 mol % or from 10 to 74.5 mol %, preferably from 10 to 68 mol % or from 10 to 60 mol %, of monomer (a),
from 20 to 89.9 mol % or from 25 to 89.5 mol %, preferably from 30 to 88 mol % or from 35 to 85 mol %, of monomer (b), and
from 0.1 to 70 mol % or from 0.5 to 65 mol %, preferably from 2 to 60 mol % or from 5 to 55 mol %, of monomer (c), relative to the total molar amount of monomers (a), (b) and (c).

According to the invention, the polymerisation reaction can use only compounds (a), (b) and (c) or use one or more other additional compounds.

The polymerisation reaction can thus also use at least one hydrophobic compound (d) different from the compound (c), preferably chosen among a compound of formula (III):

R¹—(EO)_{q}—(PO)ᵣ—OH (III)
wherein:
q and r, identical or different, independently represent 0 or an integer or decimal less than 150, q or r being different from 0,
EO independently represents a CH₂CH₂O group,
PO independently represents a group chosen among CH(CH₃)CH₂O and CH₂CH(CH₃)O,
R¹ independently represents a straight or branched C₆-C₄₀-alkyl group, a phenyl group, a polyphenyl group, preferably a straight or branched C₁₀-C₃₀-alkyl group, more preferentially a straight or branched C₁₂-C₂₂-alkyl group, or a group comprising 2 to 5 phenyls or a tristyrylphenyl group or a pentastyrylcumylphenyl group, preferably less than 20 mol %, preferably from 0.05 to 20 mol %, in particular from 0.1 to 10 mol %, of compound (d) relative to the total molar amount of compounds used.

The copolymer P according to the invention can be used in many technical fields, particularly as a rheology control agent. It can be incorporated into different compositions. Thus, the invention provides a rheology control composition comprising at least one copolymer P according to the invention. The rheology control composition according to the invention can be acid-treated to a pH below 8, preferably to a pH above 6. This treatment can be carried out using an acid, in particular a carboxylic acid such as acetic acid or lactic acid.

The rheology control composition according to the invention can also comprise at least one solvent, in particular water or a coalescent solvent, for example glycol, butyl glycol, butyldiglycol, monopropylene glycol, ethylene glycol, ethylene diglycol, “Dowanol” products with CAS number 34590-94-8), “Texanol” products with CAS number 25265-77-4); or combined with at least one additive chosen among an amphiphilic compound, in particular a surfactant compound, preferably a hydroxylated surfactant compound, for example alkyl-polyalkylene glycol, particularly alkyl-polyethylene glycol and alkyl-polypropylene glycol; a polysaccharide derivative, for example cyclodextrin, cyclodextrin derivative, polyethers, alkyl-glucosides; a hydrotropic compound, an anti-foaming agent, a biocide and combinations thereof.

The rheology control composition according to the invention is particularly suitable for facilitating the use of pigments in an aqueous medium, in particular organic or mineral pigments. It can be incorporated into a specific pigment formulation. The invention thus provides an aqueous formulation comprising:
at least one rheology control composition according to the invention; optionally
at least one organic or mineral pigment or organic, organo-metallic or mineral particles, for example calcium carbonate, talc, kaolin, mica, silicates, silica, metal oxides, in particular titanium dioxide, iron oxides; and optionally
at least one agent chosen among a particle-spacer agent, a dispersing agent, a stabilising steric agent, an electrostatic stabilising agent, an opacifying agent, a colouring agent, a solvent, a coalescing agent, an anti-foaming agent, a preservative agent, a biocide, a spreading agent, a thickening agent, a film-forming copolymer and mixtures thereof. Preferably, the formulation according to the invention is a coating formulation, in particular an ink formulation, a varnish formulation, an adhesive formulation, a paint formulation, for example a decorative paint or an industrial paint formulation. The copolymer P according to the invention can also be used in the printing field, in particular textile printing. The invention thus also provides a concentrated aqueous pigment pulp comprising at least one copolymer P according to the invention and at least one coloured organic or mineral pigment.

The invention also provides a method for controlling the viscosity of an aqueous composition that includes the addition of at least one copolymer P according to the invention to this composition. The viscosity control method according to the invention is used for an aqueous composition that is an aqueous formulation according to the invention.

The advantageous, particular or preferred features of the copolymer P according to the invention define rheology control compositions, aqueous formulations, pigment pulp as well as viscosity control methods according to the invention which are also advantageous, particular or preferred.

The following examples illustrate the various aspects of the invention.

### EXAMPLES

### Example 1: Preparation and Characterisation of Copolymer (P1) According to the Invention

In a 3 L glass reactor equipped with a mechanical stirring rod, a vacuum pump, and a nitrogen inlet and heated using a double jacket in which oil circulates, a compound (b) (polyethylene glycol-molecular mass 10,000 g/mol) (148.6 g) is introduced and heated to 95° C. under vacuum. Under stirring and in an inert atmosphere, 200 ppm of a bismuth carboxylate-type catalyst (K Kat B221) is added to the medium then a compound (c) (prepared by dimerisation by Guerbet reaction of a compound of formula I wherein R represents a straight C₅-alkyl group, m represents 0 and n represents 5 and of a compound of formula I wherein R represents a straight C₇-alkyl group, m represents 0 and n represents 4, non-ethoxylated-“Isofol” 2426S) (16.4 g), is added over 5 min. Then, a diisocyanate compound (a1) (isophorone diisocyanate, IPDI) (9.9 g) is introduced with a syringe under stirring at 150 rpm. The reaction is continued for 1 hour at 100° C.

The isocyanate level is then checked by back-assay to ensure that it is zero. 1 gram is collected from the reaction medium to which an excess of dibutylamine (1 mol, for example) is added, which reacts with any isocyanate groups potentially present in the medium. Any unreacted dibutylamine is then assayed with hydrochloric acid (1 N, for example). The number of isocyanate groups present in the reaction medium can then be deduced. If this number is not zero, the reaction is continued for 15-minute periods until the reaction is completed. When the level reaches zero, copolymer PI is obtained, comprising 14 mol % of compound a, 43 mol % of compound b and 43 mol % of compound c. It is formulated with an ethoxylated alcohol-type surfactant compound (“Emulan” HE 51 “Basf”) (95 g), 1,000 ppm of a biocide (“Biopol” SMV “Chemipol”), 1,000 ppm of an anti-foaming agent (“Tego” 1488 “Evonik”) and water (730 g). An aqueous composition is obtained consisting of 17.5% by mass of the copolymer P1 according to the invention, 9.5% by mass of surfactant compound and 73% by mass of water.

### Example 2: Preparation and Characterisation of an Aqueous Paint Formulation According to the Invention

By mixing the various ingredients under stirring, a matt paint formulation is prepared according to the invention. The compounds and amounts (g) used are listed in Table 1.

TABLE 1

| Ingredients in the matt paint formulation | Amount (g) |
|---|---|
| “Ecodis” P50 (“Coatex” dispersant) | 2.00 |
| “Tego” 810 (“Tego” anti-foaming agent) | 0.51 |
| “Acticide” MBS (“Thor” bactericide) | 1.00 |
| “Tiona” 568 (“Tronox” TiO₂) | 40.01 |
| “Omyacoat” 850 OG (”“Omya” CaCO₃) | 110.00 |
| “Durcal” 2 AV (“Omya” CaCO₃) | 150.29 |
| “Acronal” S790 (“Basf” binder) | 65.00 |
| Monopropylene glycol | 5.06 |
| “Texanol”” (“Eastman” coalescent) | 5.02 |
| NaOH (20% in water) | 0.41 |
| Aqueous composition of copolymer | 6.29 |
| P1 according to the invention | |
| Water | 114.41 |
| Total | 500.00 |

The paint formulation is then coloured by adding 5% by weight of a black pigment (“Colanyl” N500 black “Clariant”) to obtain the formulation F1 according to the invention.

Then, for the formulation F1, the following are measured at 25° C.:
the Brookfield viscosity at 10 rpm (μB10, mPa·s);
the Brookfield viscosity at 100 rpm (μB100, mPa·s);
the Cone Plan viscosity or ICI viscosity, measured at high shear gradient (μI, mPa·s);
the Stormer viscosity, measured using the reference modulus at medium shear gradient (μS, Krebs Units or KUs).

The results are measured immediately after the addition of the black pigment (T=0) and measured 24 hours after this addition (T=24 H). They are shown in Table 2.

The pigment compatibility of the formulation F1 is assessed on a dry coat of paint. The colour of the initially white paint is obtained by adding 5% of black pigment-based colouring agent (“Colanyl” N500 black “Clariant”); this percentage is calculated relative to the weight of the white paint formulation.

The rub-out test, which is known per se, involves using a finger to rub out coloured paint applied as a wet layer 150 micrometres thick on a contrast chart. This makes it possible to expose a small part of the surface finish of the layer of freshly applied coloured paint to a shear effect generated by a circular movement of the finger. The shear effect can change the stability and distribution of the coloured pigment in the matrix constituted by the layer of coloured paint and, consequently, the intensity of the colour in the sheared area. When the layer of coloured paint is dry, the difference in colour between the initially sheared area of the layer of coloured paint and the unsheared area of coloured paint is measured using a “Byk” Spectro-Guide Sphere Gloss spectrophotometer.

The colour difference is quantified by the ΔE value calculated from the measurement parameters corresponding to the known L*a*b* colour space. A low ΔE value indicates a reduced colour difference between the sheared and unsheared areas and therefore improved pigment compatibility.

The unsheared area of coloured paint is also measured against one of the L*a*b* colour space parameters. Parameter L* quantifies the intensity of the colour. A low L* value indicates reduced brightness and therefore greater black intensity, corresponding to improved pigment compatibility of the paint formulation being assessed in which the copolymer according to the invention is used. The results are shown in Table 2.

TABLE 2

| Viscosity (mPa · s) | | Formulation F1 |
|---|---|---|
| μB10 | T = 0 | 24,900 |
| μB100 | | 3,035 |
| μS | | 107 |
| μI | | 60 |
| μB10 | T = 24 | 24,050 |
| μB100 | HRS | 3,155 |
| μS | | 109 |
| μI | | 60 |

Pigment compatibility

| | |
|---|---|
| ΔE | 3.15 |
| L* | 34.07 |

For the formulation F1 according to the invention, the copolymer according to the invention makes it possible to control the various components of the viscosity, both after preparation and over time. The copolymer according to the invention confers good pigment compatibility to this paint formulation.

1. A copolymer P prepared by at least one of: polymerisation reaction
at least one isocyanate compound (a) selected from the group consisting of a diisocyanate compound (a1), a polyisocyanate compound (a2) and combinations thereof;
at least one polyhydroxylated compound (b); and
at least one compound (c) obtained by dimerisation, by a Guerbet reaction, of two identical or different compounds of formula I:
R—CH[(CH₂)ₘCH₃]—(CH₂)ₙ—OH (I)
wherein:
R independently represents a straight C₄-C₉-alkyl group;
m independently represents 0 or 1; and
n independently represents a number ranging from 2 to 7.

2. The copolymer P of claim 1, wherein the isocyanate compound (a) is:
a diisocyanate compound (a1) selected from the group consisting of:
a symmetric aromatic diisocyanate compound,
a symmetric alicyclic diisocyanate compound,
a symmetric aliphatic diisocyanate compound,
an asymmetric aromatic diisocyanate compound,
an asymmetric alicyclic diisocyanate compound,
a polyisocyanate compound (a2) comprising more than 2 isocyanate groups
an isocyanurate compound selected from the group consisting of:
a symmetric aromatic diisocyanate compound,
a symmetric alicyclic diisocyanate compound,
a symmetric aliphatic diisocyanate compound; and
an asymmetric aromatic diisocyanate compounds,
a biuret trimer compound selected from the group consisting of:
a symmetric aromatic diisocyanate compound,
a symmetric alicyclic diisocyanate compound,
a symmetric aliphatic diisocyanate compound,
an asymmetric aromatic diisocyanate compounds; and
an asymmetric alicyclic diisocyanate compound.

3. The copolymer P of claim 1, wherein polyhydroxylated compound (b) is selected from the group consisting of:
a compound (b1) of formula II:
HO—Lₚ—OH (II)
wherein:
L independently represents an oxyalkylene residue;
p independently represents a number ranging from 30 to 1,000;
a compound (b1) of formula II combined with a non-alkoxylated compound (b2) comprising at least three hydroxyl groups; and
a polyalkoxylated compound (b3) comprising at least three hydroxyl groups.

4. The copolymer P of claim 1, wherein the polyhydroxylated compound (b) is selected from the group consisting of:
a compound (b1) of formula II
HO—Lₚ—OH (II),
wherein:
L independently represents an oxyethylene residue; or
p independently represents a number ranging from 50 to 400; or
L independently represents an oxyethylene residue and p independently represents a number ranging from 50 to 400;
a compound (b2) comprising three hydroxyl groups; and
polyethoxylated pentaerythritol or a compound (b3) different from the compound (b2) and comprising three hydroxyl groups.

5. The copolymer P of claim 1, wherein the polyhydroxylated compound (b) has a molar mass (Mw) measured by SEC ranging from 1,500 to 40,000 g/mol.

6. The copolymer P of claim 1, wherein:
the dimerisation of two identical compounds of formula I results in a homodimer (c1),
compound (c) is a homodimer (c1) obtained by dimerisation of two identical compounds of formula I wherein:
R represents a straight C₅-C₇-alkyl group;
m represents 0 or 1; and
n represents a number ranging from 2 to 7; or
compound (c) is a homodimer (c1) obtained by dimerisation of two identical compounds of formula I wherein:
R represents a straight C₄-C₉-alkyl group;
m represents 0 or 1; and
n represents a number ranging from 5 to 7.

7. The copolymer P of claim 1, wherien:
the dimerisation of two different compounds of formula I results in a mixture comprising 2 different homodimers (c1) and a heterodimer (c2);
a mixture of compounds (c) is obtained by dimerisation of two different compounds of formula I wherein:
R independently represents a straight C₅-C₇-alkyl group;
m independently represents 0 or 1; and
n independently represents a number ranging from 2 to 7;
a mixture of compounds (c) is obtained by dimerisation of two different compounds of formula I wherein:
R independently represents a straight C₄-C₉-alkyl group;
m independently represents 0 or 1; and
n independently represents a number ranging from 5 to 7; or
a mixture of compounds (c) comprises a heterodimer compound (c2) obtained by dimerisation of a first compound of formula I wherein R represents a straight C₅-alkyl group, m represents 0 and n represents 5 and of a second different compound of formula I wherein R represents a straight C₇-alkyl group, m represents 0 and n represents 4; or
a mixture of compounds (c) comprises:
a heterodimer compound (c2) obtained by dimerisation of a first compound of formula I wherein R represents a straight C₅-alkyl group, m represents 0 and n represents 5 and of a second different compound of formula I wherein R represents a straight C₇-alkyl group, m represents 0 and n represents 4,
a first homodimer (c1) obtained by dimerisation of a compound of formula I wherein R represents a straight C₅-alkyl group, m represents 0 and n represents 5,
a second homodimer (c1) obtained by dimerisation of a different compound of formula I wherein R represents a straight C₇-alkyl group, m represents 0 and n represents 4.

8. The copolymer P of claim 1, wherein the polymerisation reaction uses:
from 10 to 79.9 mol % of monomer (a) or
from 20 to 89.9 mol of monomer (b), or
from 0.1 to 70 mol % of monomer (c), each relative to a total molar amount of monomers (a), (b) and (c).

9. The copolymer P of claim 1, wherein the polymerisation reaction also uses at least one hydrophobic compound (d) different from compound (c), compound (d) being at least one selected from the group consisting of
a compound of formula (III):
R¹—(EO)_{q}—(PO)ᵣ—OH (III)
wherein:
q and r, identical or different, independently represent 0 or an integer or decimal less than 150, q or r being different from 0,
EO independently represents a CH₂CH₂O group,
PO independently represents a group selected from the group consisting of CH(CH₃)CH₂O and CH₂CH(CH₃)O,
R¹ independently represents a straight or branched C₆-C₄₀-alkyl group, a phenyl group, or a polyphenyl group.

10. A rheology control composition, comprising a copolymer P of claim 1.

11. The rheology control composition of claim 10, further comprising at least one selected from the group consisting of
a solvent; and
an additive selected from the group consisting of
an amphiphilic compound;
a polysaccharide derivative;
a hydrotropic compound; an anti-foaming agent; and
a biocide.

12. A coating formulation, comprising:
a rheology control composition of claim 10;
and optionally comprising at least one selected from the group consisting of
an organic or mineral pigment or organic, organo-metallic or mineral particle; and,
at least one agent selected from the group consisting of a particle-spacer agent, a dispersing agent, a stabilising steric agent, an electrostatic stabilising agent, an opacifying agent, a colouring agent, a solvent, a coalescing agent, an anti-foaming agent, a preservative agent, a biocide, a spreading agent, a thickening agent, and a film-forming copolymer.

13. The coating formulation of claim 12 which is at least one selected from the group consisting of an ink formulation, a varnish formulation, an adhesive formulation, and a paint formulation.

14. A concentrated aqueous pigment pulp comprising
a copolymer P of claim 1, and
a coloured organic or mineral pigment.

15. A method for controlling the viscosity of an aqueous composition, the method comprising adding a copolymer P of claim 1 to the aqueous composition.

16. The method of claim 15, wherein the aqueous composition is a formulation comprising at least one selected from the group consisting of
an organic or mineral pigment or organic, organo-metallic or mineral particle; and
at least one agent selected from the group consisting of a particle-spacer agent, a dispersing agent, a stabilising steric agent, an electrostatic stabilising agent, an opacifying agent, a colouring agent, a solvent, a coalescing agent, an anti-foaming agent, a preservative agent, a biocide, a spreading agent, a thickening agent, and a film-forming copolymer.
